(19) United States
(12) Patent Application Publication
(10) Pub. No.: US 2013/0322820 A1
(43) Pub. Date: Dec. 5, 2013

(54) OPTICAL FIBER FOR A LIGHTING DEVICE

(71) Applicant: Automotive Lighting Reutlingen GmbH, Reutlingen (DE)

(72) Inventors: Hubert Zwick, Stuttgart (DE); Hermann Kellermann, Reutlingen (DE)

(21) Appl. No.: 13/905,557

(22) Filed: May 30, 2013

(30) Foreign Application Priority Data
Jun. 1, 2012 (DE) 10 2012 209 337.0

(51) Int. Cl. G02B 6/26; G02B 6/34

(52) U.S. Cl. CPC G02B 6/262; G02B 6/34
USPC 385/31

(57) ABSTRACT

An optical fiber for a lighting device comprises: a coupling section that exhibits at least one coupling surface for coupling of light in the optical fiber; a fiber-optics section that extends along a main fiber-optics line that is limited by at least one main fiber-optics surface extending along the main fiber-optics line and such that the light can be conducted along the main fiber-optics line, starting from the coupling section, by internal total reflection at the main fiber-optics surface; and a plurality of decoupling components. Each decoupling component is disposed on the main fiber-optics surface such that light from the optical fiber can be fully decoupled by a respective light-emitting surface of the optical fiber assigned thereto. The decoupling components on the main fiber-optics surface are disposed such that they are offset along the main fiber-optics line. A fiber-optics device comprises first and second ones of the optical fiber.

### CROSS-REFERENCE TO RELATED APPLICATION

This application is based upon and claims priority to German Patent Application 10 2012 209 337.0 filed on Jun. 1, 2012.

### BACKGROUND OF INVENTION

1. Field of Invention

The invention relates to an optical fiber for a lighting device comprising: a coupling section that exhibits at least one coupling surface for coupling of light in the optical fiber; a fiber-optics section that extends along a main fiber-optics line that is limited by at least one first main fiber-optics surface extending along the main fiber-optics line and such that light can be guided along the main fiber-optics line, starting from the coupling section, by internal total reflection occurring at least in sections on the main fiber-optics surface; and a plurality of decoupling components. Each decoupling component is disposed on the main fiber-optics surface such that light from the optical fiber can be fully decoupled by one of the respective light-emitting surfaces of the optical fiber assigned to the decoupling component. The decoupling components are disposed at various positions on the main fiber-optics surface.

The invention relates to also a fiber-optics device. The fiber-optics device comprises first and second ones of the optical fiber. The first optical fiber is connected by an end section, which limits the first optical fiber in a direction substantially opposite the coupling section of the first optical fiber, to an end section of the second optical fiber, which limits the second optical fiber in a direction substantially opposite the coupling section of the second optical fiber.

2. Description of Related Art

Optical fibers are used, for example, in lighting devices or headlights in the automotive field. For this, light distributions are normally stipulated by law, which extend in a defined range having a horizontal spread from −20°-+20° and a vertical spread from −10°-+10°.

From EP 1 022 510 A2, a longitudinally extended optical distributer made of a transparent material is known. This optical distributer exhibits an input section into which light can be projected in a “beam” direction. Furthermore, the optical distributer exhibits a back surface running diagonally to the “projection” direction. Reflecting facets are disposed on the back surface each of which reflects partial bundles of the projected light and can deflect in a direction deviating from the “beam” direction. In this respect, the optical distributer described in EP 1 022 510 A2 does not relate to an optical fiber, but, rather, a transparent body having mirror components in the form of facets offset along the projection axis (i.e., it relates to a “distributed mirror.”).

With the optical fiber as set forth in the invention, however, light is conducted by multiple reflections in the optical fiber along the main fiber-optics line. Light is decoupled at various positions along the main fiber-optics line by the decoupling components disposed along the main fiber-optics line on the fiber-optics section.

In this connection, there is, however, the problem that only a certain part of the entering light is decoupled by the decoupling component. The majority of the light entering is lost through the end surface limiting the fiber-optics section in the direction opposite the coupling section, which means it is not deflected in the desired direction.

Furthermore, the intensity of the light in the optical fiber starting from the coupling section is diminished due to the decoupling. For this reason, increasingly less light is available for a decoupling. As a result, the decoupled light decreases in intensity along the main fiber-optics line, which, depending on the use thereof, may be undesired.

The objective of the invention is to likewise decouple the remaining light that is lost (referred to above) by the decoupling components. At the same time, the entering-light intensity should be uniformly distributed to the greatest extent possible or be distributed in a substantially definable manner to the various decoupling components.

### SUMMARY OF INVENTION

The invention overcomes problems in the related art in an optical fiber for a lighting device. The optical fiber comprises: a coupling section that exhibits at least one coupling surface for coupling of light in the optical fiber; a fiber-optics section that extends along a main fiber-optics line that is limited by at least one main fiber-optics surface extending along the main fiber-optics line and such that light can be conducted, starting from the coupling section, by total reflection at the main fiber-optics surface along the main fiber-optics line; and a plurality of decoupling components. Each of the decoupling components is disposed on the main fiber-optics surface such that light from the optical fiber can be fully decoupled by a light-emitting surface of the optical fiber assigned in each case thereto. The decoupling components are disposed on the main fiber-optics surfaces such that they are offset along the main fiber-optics line. The fiber-optics section exhibits regions having an optical-fiber cross-section decreasing in a direction starting from the coupling section along the main fiber-optics line.

The invention overcomes problems in the related art in also a fiber-optics device. The fiber-optics device comprises first and second ones of the optical fiber. The first optical fiber is connected by an end section, which limits the first optical fiber in a direction substantially opposite the coupling section of the first optical fiber, to an end section of the second optical fiber, which limits the second optical fiber in a direction substantially opposite the coupling section of the second optical fiber.

Accordingly, the fiber-optics section of an optical fiber of the type specified in the introduction exhibits regions in which the optical-fiber cross-section decreases in the direction starting from the coupling section along the main fiber-optics line. In particular, the optical-fiber cross-section decreases over the entire length of the fiber-optics section along the main fiber-optics line starting from the coupling section.

For this, an optical fiber is concerned in which the light conduction occurs by, in particular, multiple internal total reflection according to the law of refraction (meaning by reflection on a surface when the critical angle of the total reflection exceeds the vertical to the surface in accordance with Snell's law). In particular, with the optical fiber, at least the main fiber-optics surface and one or more additional fiber-optics surface(s) extending along the main fiber-optics line is/are provided, which are designed and disposed such that light can be conducted, at least in sections, along the main fiber-optics line by the resulting total reflection at the main fiber-optics surface or the other fiber-optics surfaces, respectively.

For this, the coupling section includes, in particular, a front surface of the optical fiber, wherein the main fiber-optics surface and the additional fiber-optics surfaces extend along the main fiber-optics line starting from the end surface.

The main fiber-optics line represents the spatial course or orientation thereby along the center of which the light energy is conducted. The main fiber-optics line exhibits, in this respect, an orientation in the form of a direction defined along the fiber-optics section starting from the coupling section.

Individual bundles of the conducted light may develop in sections also in the directions deviating from the main fiber-optics line (in particular, with multiple reflections at the fiber-optics surface in alternating directions).

It is also important that the main fiber-optics surface is not designed such that all of the light is relayed. Instead, it is sufficient if can be conducted, at least in part, by the resulting total reflection along the main fiber-optics line.

The light-emitting surface of the optical fiber assigned to the respective decoupling component can be, but is not necessarily, disposed on the respective decoupling component. It is assigned to the component in this respect such that, through it, the decoupled light exits from the optical fiber.

The optical-fiber cross-section in the present case is understood to mean the cross-section area functioning for the conducting of light in the fiber-optics section within suitable sections in relation to the main fiber-optics line (in particular, perpendicular to the main fiber-optics line in the respective positions).

The optical-fiber cross-section can decrease along the main fiber-optics line in a continuous manner (in particular, following a definable curve). It is, however, also conceivable that the optical-fiber cross-section decreases discreetly (i.e., in steps). In this respect, it is conceivable that there are successive regions along the main fiber-optics line, wherein the optical-fiber cross-section remains uniform in each of these regions, but each region, in relation to the previous region, exhibits a smaller or equal-sized optical-fiber cross-section. For this, the optical-fiber cross-section does not need to taper in a uniform manner. It is also conceivable that the optical-fiber cross-section exhibits expanded optical-fiber cross-sections in sections along the main fiber-optics line while still exhibiting a tapering optical-fiber cross-section along the main fiber-optics line starting from the coupling section regions.

In an embodiment, the optical fiber is made of a material that is transparent for visible light [in particular, glass or transparent plastic (e.g., acrylic glass or polycarbonate)]. Materials of this type exhibit a greater optical density than air and, therefore, a greater refractive index.

In an embodiment, a design of the optical fiber is obtained in that, starting from the coupling section, the dimensions of the fiber-optics section along the main fiber-optics line decrease at a right angle to the main fiber-optics surface.

This can be obtained, for example, in that a fiber-optics section, which is limited by the main fiber-optics surface and a fiber-optics surface lying opposite thereto, is designed such that the main fiber-optics surface and the opposite surface converge along the main fiber-optics line starting from the coupling section (meaning that the spacing between the main fiber-optics surface and the opposite fiber-optics surface decreases along the main fiber-optics line).

For the introduction of light from the fiber-optics section into the decoupling component, angular components of light beams perpendicular to the main fiber-optics surface are substantially decisive. If the dimensions decrease perpendicular to the main fiber-optics surface, then, as a result, an increasing portion of the still-present light can be introduced along the main fiber-optics line at the respective position along the main fiber-optics line. By this, the brightness of the light deflected by various decoupling components can be affected as required or maintained at the greatest possible degree of uniformity.

The decoupling components are of substantial importance in the optical fiber according to the invention. If the main fiber-optics surface and an opposite fiber-optics surface converge continuously without decoupling components being provided, then a light beam would strike the respective opposite fiber-optics surface at a steeper angle alter each total reflection. For this reason, with each total reflection, the angular component would increase at a right angle to the fiber-optics surface. In this case, the critical angle of the total reflection would then be exceeded, and light would be emitted from the optical fiber. By the decoupling component, instead of an undesired decoupling of this type, the position of the light-emitting surface is defined.

For the second design, it is provided that the dimensions of the fiber-optics section decrease along the main fiber-optics line in a direction parallel with the main fiber-optics surface. By a lateral cross-section tapering of this type, an additional concentration of the light conducted into the optical fiber can be obtained in the course following the main fiber-optics line. As a result, an additionally increased light density is available for the decoupling component spaced at a distance from the coupling section. This contributes to a uniform light distribution over all of the decoupling components.

Alternatively, it may be advantageous if the dimensions of the fiber-optics section remain undiminished in the direction parallel with the main fiber-optics surface (in particular, if they remain constant or increase in sections). As a result, a constant surface or an increasing surface is available for the decoupling along the fiber-optics section.

The fiber-optics section is, in an embodiment, designed such that it is plate-shaped or in the shape of a rod. Furthermore, the fiber-optics section can be straight or curved. The same applies for the design of the main fiber-optics surface.

In particular, the fiber-optics section is designed such that the main fiber-optics surface follows a spatial curve (in particular, having multiple curves). With an optical fiber of this type, the main fiber-optics line substantially follows the course of the optical fiber and is, therefore, also curved in a corresponding manner. A bent or curved design is frequently desirable for use in the field of motor-vehicle headlights.

To further increase the portion of the light decoupled by the decoupling component, for one thing, it may be provided that the fiber-optics section exhibits an end surface, which limits the fiber-optics section in its direction facing away from the coupling section along the main fiber-optics line, wherein the end surface exhibits a smaller surface area than the smallest optical-fiber cross-section along the main fiber-optics line.

Furthermore, the portion of decoupled light can be increased in that the end surface is disposed such that for a light bundle running along the main fiber-optics line in the fiber-optics section, an internal total reflection occurs at the end surface.

Another aspect of the invention is that the decoupling component exhibits at least one total-reflection surface, which is disposed such that, for a light bundle running from the fiber-optics section into the decoupling component, an internal total reflection occurs at the total-reflection surface.

By this, light is deflected in a direction deviating from the main fiber-optics line. Thus, a desired decoupled light distribution can be obtained. Alternatively, it is conceivable that no total reflection occurs at the decoupling component, and the desired deflection occurs solely due to refraction.

The optical fiber is further developed in that the light-emitting surface assigned to the respective decoupling component is disposed on the respective decoupling component. On the other hand, it may be advantageous that the light-emitting surface assigned to a decoupling component is not disposed on the decoupling component itself, but, instead, on the fiber-optics section (in particular, in a region of the fiber-optics section vertically opposite the respective decoupling component in respect to the main fiber-optics line). Depending on the structural requirements, the configuration of the light-emitting surface on the decoupling component or on the fiber-optics section can be advantageous. Thus, for example, it may be advantageous if the light-emitting surface assigned to the respective decoupling component is disposed on the respective decoupling component and the light-emitting surface extends substantially perpendicular to the main fiber-optics section and/or to another fiber-optics surface of the fiber-optics section.

The decoupling components themselves are, in an embodiment, designed as bodies disposed or placed on the main fiber-optics surface. They can, for example, be in the shape of a prism, a rectangular solid, a cube, a “sphere” segment, or a “cylinder” segment or have a saw-tooth design.

According to one possible design of the optical fiber, all of the decoupling components have an identical form. It is, however, also conceivable that the decoupling components are designed such that they are at least in part different. In particular, different decoupling components may exhibit different dimensions. This enables an adjustment of the decoupled light distribution as required.

A particular design can be obtained in that the decoupling components are each connected by a decoupling surface to the main fiber-optics surface. In particular, the decoupling components are placed directly on the main fiber-optics surface with the specified decoupling surface. For this, the connection is, in an embodiment, such that the fiber-optics section and the decoupling component are designed as a single unit. In this case, the decoupling surface is a shared surface including the decoupling component and the fiber-optics section. The specified designs, thereby, contribute to the prevention of “Fresnel” losses or losses due to reflection at the border surfaces when light enters a decoupling component.

To obtain the greatest degree of consistency in the decoupling of light along the fiber-optics section, the decoupling components can be disposed along the main fiber-optics line such that they are directly adjacent to one another on the main fiber-optics surface.

On the other hand, it may be advantageous if the fiber-optics section exhibits numerous sub-sections, wherein one sub-section is disposed, in each case, between two successive decoupling components along the main fiber-optics line. In this respect, the decoupling components are separated spatially by the respective sub-sections lying between them.

For this, it is possible to design a sub-section such that it exhibits an expanding optical-fiber cross-section, at least in sections, along the main fiber-optics line in the direction starting from the coupling section.

A sub-section of this type, having an expanding cross-section, leads to a parallelization of the light passing through it. With each reflection of a light beam conducted through the optical fiber at two fiber-optics surfaces running at an angle to one another, the angle where the light beams diverge in relation to the optical axis decreases. This leads to a narrowing of a light bundle conducted through the optical fiber with each reflection. As a result, light bundles can, in each case, be parallelized prior to each decoupling component, which can contribute to an increase in the efficiency of the decoupling.

According to a particular design, the fiber-optics section exhibits a design by which the main fiber-optics surface forms numerous terraces along the main fiber-optics line, wherein one decoupling component is disposed on each terrace. In an embodiment, a terrace extends, in each case, over one of the aforementioned sub-sections.

A sub-section of this type, having an expanding cross-section, leads to a parallelization of the light passing through it. With each reflection of a light beam, conducted in the optical fiber at two fiber-optics surfaces running toward one another at an angle, the angle where the light beams diverge in relation to the optical axis decreases. This leads to a narrowing of the light bundle conducted in the optical fiber with each reflection. As a result, light bundles can each be parallelized by a decoupling component, which can contribute to an increase in the decoupling efficiency.

According to a particular design, the fiber-optics section exhibits a design in which the main fiber-optics surface forms numerous terraces along the main fiber-optics line, wherein a decoupling component is disposed on each terrace. In an embodiment, a terrace extends, in each case, over one of the aforementioned sub-sections.

For this, the reduction of the cross-section can be obtained in that the fiber-optics section between two successive terraces along the main fiber-optics line exhibits a step. The optical-fiber cross-section, thus, does not decrease in a continuous manner, but rather in steps.

According to another aspect, each terrace includes, in each case, one of the aforementioned sub-sections and one decoupling region bordering the sub-section. For this, in each case, a decoupling component is disposed at the decoupling region, and the fiber-optics section is designed such that it exhibits a consistent cross-section in the decoupling region. Because the fiber-optics section exhibits a consistent cross-section in the decoupling region, defined retraction characteristics can be provided for the light decoupling at the respective decoupling component.

The fiber-optics section is limited, in particular, by at least one additional main fiber-optics surface, which extends along the main fiber-optics line. The additional fiber-optics surface runs, in particular, parallel with the first main fiber-optics surface or parallel with yet another main fiber-optics surface. In particular, the additional main fiber-optics surface runs such that it directly borders the first or another main fiber-optics surface [meaning that the additional and the first (or other) main fiber-optics surface exhibit a shared edge running, for example, along the main fiber-optics surface].

The specified additional main fiber-optics surface assumes a corresponding function thereby like that of the main fiber-optics surface described above. In particular, there are numerous decoupling components disposed in the manner described above on the additional main fiber-optics surface. In this respect, for further designs of the specified additional main fiber-optics surface, reference is made to the designs of the main fiber-optics surface described above.

A particularly homogenous decoupled light distribution can be obtained, for example, in that numerous decoupling components are also disposed on the main fiber-optics surface such that the light exiting the optical fiber can be decoupled by a respective light-emitting surface of the optical fiber assigned thereto, wherein the decoupling components on the additional main fiber-optics surface and the decoupling components on the first main fiber-optics surface are disposed such that they are offset to one another along the main fiber-optics line. It is, however, also conceivable that the decoupling components on the various main fiber-optics surfaces are each disposed at the same positions along the main fiber-optics line. In the latter case, particularly high intensities of the decoupled light result, in each case, at these positions.

In an embodiment, the specified additional main fiber-optics surface and the first main fiber-optics surface exhibit the same dimensions perpendicular to the main fiber-optics line. In this respect, the first and the additional main fiber-optics surfaces run next to one another in the manner of stripes having the same width. A design having stripes of different widths for the different main fiber-optics surfaces is, however, also conceivable.

It may also be advantageous with the optical fiber according to the invention if the coupling section exhibits numerous coupling surfaces. By this, it is possible, for example, to supply the optical fiber with different light sources. For this, different light sources can, for example, provide different colors.

The objective specified in the introduction is also attained by a fiber-optics device, which is formed in that a first optical fiber of the aforementioned type is connected to a second optical fiber of the aforementioned type. The connection is obtained, thereby, in that the first optical fiber is connected by an end section, which limits the first optical fiber in the direction opposite its coupling section, to an end section of the second optical fiber, which limits the second optical fiber in the direction opposite its coupling section. This connection is designed, in particular, to be a single unit such that there is no border surface where refection effects can occur.

To attain the objective defined in the introduction, lastly, a lighting device is proposed, which includes a least one optical fiber of the type described above. Furthermore, a lighting device, such as an LED or semiconductor light source, for example, can be provided with which light can projected into the optical fiber. For this, the lighting device is configured such that the emitted light can be coupled in the fiber-optics section by the coupling section.

Other objects, features, and advantages of the invention are readily appreciated as it becomes more understood while the subsequent detailed description of at least one embodiment of the invention is read taken in conjunction with the accompanying drawing thereof.

### BRIEF DESCRIPTION OF EACH FIGURE OF DRAWING OF INVENTION

FIG. 1 is a schematic depiction of an optical fiber for explanation of the functional principles in a top view;

FIG. 2 is the optical fiber according to FIG. 1 in a perspective view;

FIG. 3 is the spatial intensity distribution of the light emitted from an optical fiber according to FIGS. 1 and 2;

FIG. 4 is the light distribution at a view of an optical fiber perpendicular to the main fiber-optics line;

FIG. 5 is an embodiment of an optical fiber according to the invention from a top view;

FIG. 6 is the optical fiber according to FIG. 5 in a side view or longitudinal section;

FIG. 7 is the optical fiber according to FIGS. 5 and 6 in a perspective depiction;

FIGS. 8 and 9 are the spatial intensity distribution of the emitted light of an optical fiber according to FIGS. 5-7;

FIG. 10 is a depiction corresponding to FIG. 4 for the optical fiber according to FIGS. 5-7;

FIG. 11 is a detailed depiction of a decoupling component for use in an optical fiber according to the invention;

FIG. 12 is an optical fiber having decoupling components according to FIG. 11;

FIG. 13 is another embodiment of an optical fiber according to the invention in a longitudinal section;

FIG. 14 is a detailed depletion of FIG. 13;

FIG. 15 is another embodiment of an optical fiber according to the invention in a longitudinal section;

FIG. 16 is another embodiment of an optical fiber according to the invention in a longitudinal section; and

FIG. 17 is the optical fiber according to FIG. 16 in a perspective depiction.

### DETAILED DESCRIPTION OF EMBODIMENTS OF INVENTION

In the following description, the same reference symbols are used in the various embodiments for identical or corresponding characteristics.

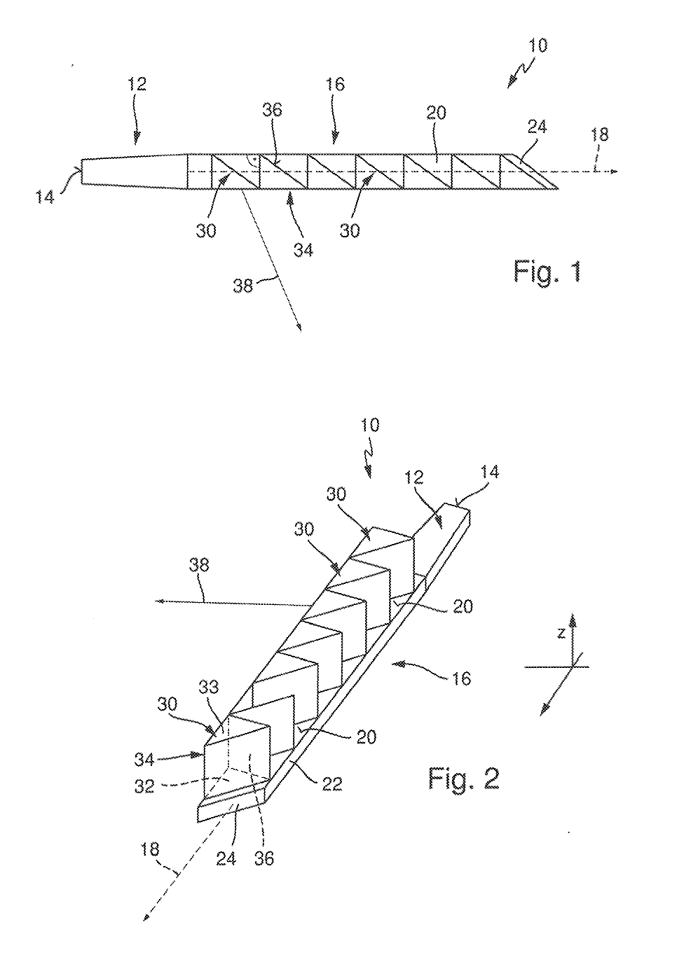

For explanation of the functional principle of the invention, an optical fiber 10 is depicted schematically in FIG. 1 in a top view. The optical fiber 10 exhibits a coupling section 12, which includes a coupling surface 14 through which light from a light source (not shown) can be coupled in the optical fiber 10.

The coupling section 12 transitions into a fiber-optics section 16 designed as a rod. The fiber-optics section 16 extends along a main fiber-optics line 18, depicted by a broken line, which is oriented toward the right hand side in the depiction in FIG. 1 starting from the coupling section 12. For this, the fiber-optics section 16 is designed such that light, which is coupled in the coupling section 12, can be conducted in the optical fiber by, in particular, numerous internal total reflections at its limiting outer surface along the main fiber-optics line 18.

The optical fiber 10 is shown in FIG. 2 in a perspective depiction to clarify further details. The fiber-optics section 16 is limited accordingly by a first main fiber-optics surface 20 extending along the main fiber-optics line 18 (FIG. 1 shows the optical fiber from a perspective looking at the first main fiber-optics surface 20).

The main fiber-optics surface 20 forms a first wide longitudinal surface of the rod-shaped fiber-optics section 16. As can be seen from FIG. 2, the fiber-optics section 16 is also limited by another fiber-optics surface 22, which forms a right angle to the first main fiber-optics surface 20 and also extends along the main fiber-optics line 18. The other fiber-optics surface 22 thus forms, in this respect, a narrow longitudinal surface of the rod-shaped fiber-optics section 16. Accordingly, the fiber-optics section 16 is limited by another [not visible in FIGS. 1 and 2 (wide)] fiber-optics surface, which lies opposite the main fiber-optics surface 20. Furthermore, the fiber-optics section 16 is limited by one of the (narrow) fiber-optics surfaces 22 lying opposite the other fiber-optics surface. Finally, the fiber-optics section 16 is limited by an end surface 24 in its region facing away from the coupling section 12 along the main fiber-optics line 18.

The coupling section 12 is designed such that it exhibits a cross-section surface perpendicular to the main fiber-optics line 18, wherein the cross-section surface increases over its course starting from the coupling surface 14 along the main fiber-optics line 18. In this respect, the coupling region 12 is limited by bordering surfaces extending along the main fiber-optics line 18, which converge, starting from the coupling surface 14, along the main fiber-optics line.

The optical fiber 10 exhibits numerous decoupling components 30. The decoupling components 30 are all designed as identical prisms, which are placed on the main fiber-optics surface 20. Each of the decoupling components 30 exhibits a decoupling surface 32, which limits the decoupling component 30. Moreover, each of the decoupling components 30 is limited by a cover surface lying opposite the decoupling surface 32 running parallel thereto. Each decoupling component 30 also exhibits a light-emitting surface 34, which forms an additional prism surface, which extends between the decoupling surface 32 and the cover surface. In the depicted case, the decoupling surface 32 is designed in the manner of a right triangle. Each of the decoupling components 30 is furthermore limited by a total-reflection surface 36, which forms a hypotenuse surface in relation to the decoupling surface 32 designed as a right triangle, which is limited by the hypotenuse of the right triangle of the decoupling surface 32.

Each of the decoupling components 30 is connected by its decoupling surface 32 to the main fiber-optics surface 20 of the fiber-optics section 16 to form a single unit. The connection between the decoupling component 30 and the fiber-optics section 16 is such, thereby, that a passage of light from the fiber-optics section 16 into the decoupling component 30 is possible, to the greatest extent possible, without a retraction effect. In an embodiment, the fiber-optics section 16 and all of the decoupling components 30 are produced as a single unit (in particular, in an injection-molding procedure).

The end surface 24 of the fiber-optics section 16 runs parallel with the total-reflection surfaces 36 of each of the decoupling components 30.

A light bundle running in the fiber-optics section 16 at an angle to the main fiber-optics line 18 can enter a decoupling component 30 through the intended decoupling surface 32. For this, the fiber-optics section 16 and the decoupling component 30 are each designed such that an entering light bundle of this type is fully reflected at the total-reflection surface in accordance with the law of refraction and, subsequently, with a suitable orientation of the light bundle, strikes the light-emitting surface 34. By the light-emitting surface 34, the reflected light bundle then exits the optical fiber 10 with a new refraction. An exiting light bundle of this type is depicted in FIGS. 1 and 2 by an arrow provided with the reference symbol 38.

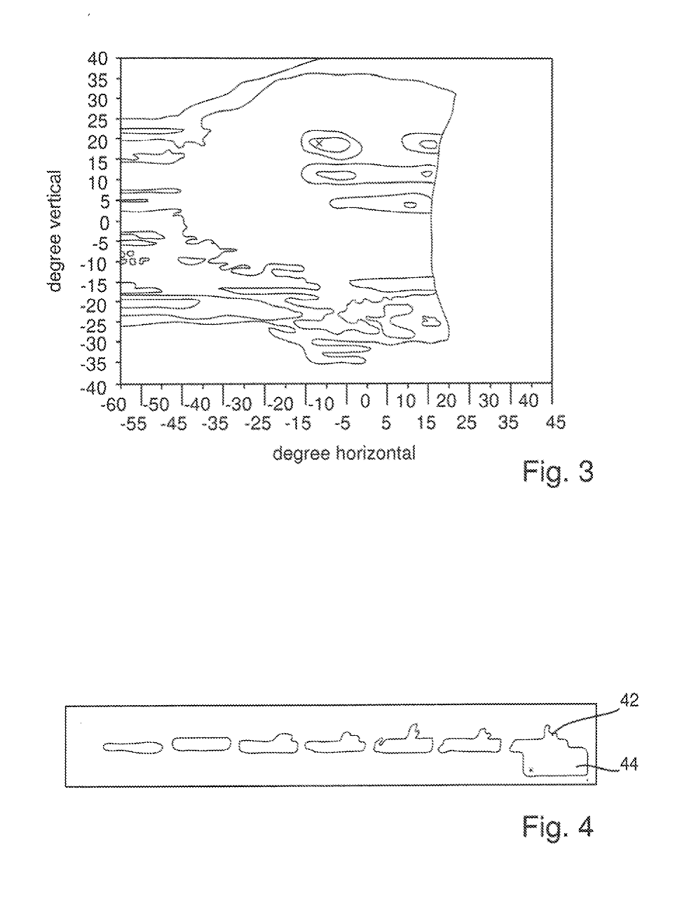

FIGS. 3 and 4 illustrate the spatial distribution of the light intensity of the decoupled light when light is coupled in the optical fiber 10 by the coupling section 12 and decoupled in the manner described above by the decoupling component 30.

For this, FIG. 3 shows the intensity distribution in a test screen extending parallel with the light-emitting surfaces 34, which is disposed at a distance to the optical fiber 10 perpendicular to the main fiber-optics line 18 in the direction of the axis of the light bundle 38. It can be seen that the majority of the light intensity is projected into the upper half of the test screen. This can be attributed to the fact that, from the fiber-optics section 16, light bundles, for the most part, are then only decoupled when they exhibit an angular component in the direction from the fiber-optics section 16 toward the first main fiber-optics surface 20 (meaning in the direction from the fiber-optics section 16 toward a decoupling component 30). Decoupled light bundles of this type, therefore, have, in the depiction according to FIG. 2 (as seen in a coordinate system), a positive z-axis component.

FIG. 4 shows the intensity distribution in a view of an illuminated optical fiber from a perspective perpendicular to the main fiber-optics line 18. In this case, the left-hand outermost light spot corresponds in FIG. 4 to the coupling component 30, which directly follows the coupling section 12 along the main fiber-optics line 18. In so doing, it can be seen that the intensity of the light decoupled by a respective decoupling component 30, starting from the coupling section 12, decreases along the main fiber-optics line 18 or the fiber-optics section 16 thereof. This can be attributed to the fact that, due to the decoupling by upstream decoupling components 30, a lower light intensity is available.

Furthermore, it can be seen that, in the region of the light spot 42 assigned to the decoupling component 30 spaced furthest from the coupling section 12 (FIG. 4), there is a region 44 having a greater intensity of decoupled light. This region is exceptional in that it is to be attributed to light bundles having negative angular components with respect to the z-axis (FIG. 2). This relates to light bundles, for example, that do not enter any of the decoupling components 30 or in their continuation are fully reflected at the main fiber-optics surface 20 along the fiber-optics section 16. These light bundles are fully reflected at the end surface 24 in a manner corresponding to total-reflection surfaces 36 and then exit, through the limiting surface of the fiber-optics section 16 lying opposite the fiber-optics surface 22, from the optical fiber 10.

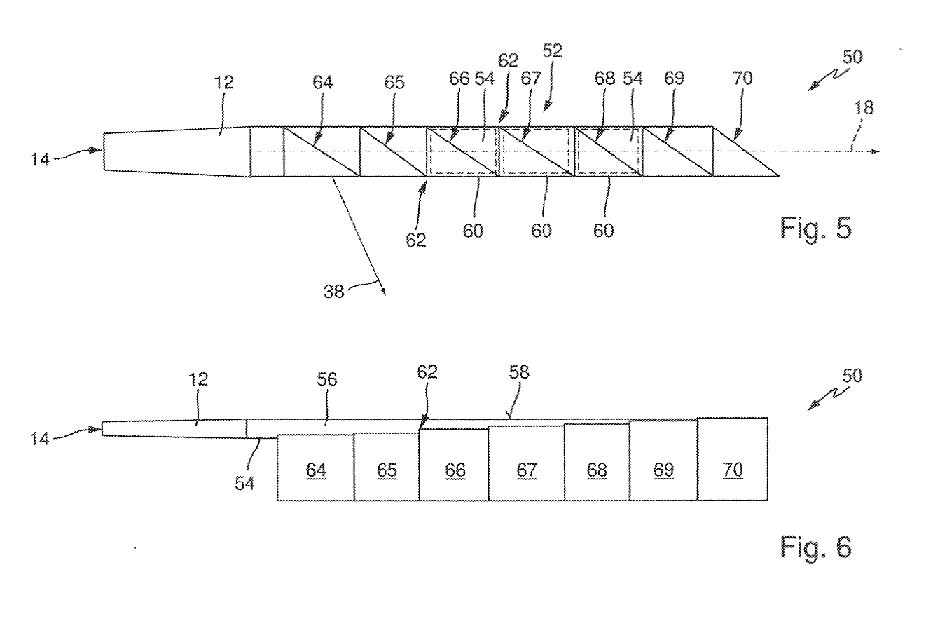

Based on FIGS. 5-7, an improved optical fiber 50 is described. This optical fiber 50 exhibits, accordingly, a coupling section 12 having a coupling surface 14 and extends along a main fiber-optics line 18. With respect to the design of this characteristic, reference is made to the description above regarding the optical fiber 10.

The optical fiber 50 exhibits, however, a fiber-optics section 52, which exhibits, in contrast to the fiber-optics section 16, a cross-section, acting on the optical fiber at a right angle to the main fiber-optics line 18, which decreases, starting from the coupling section 12, along the main fiber-optics line.

The fiber-optics section 52 is limited by a first main fiber-optics surface 54 and a counter-fiber-optics surface 58 lying opposite thereto (which forms another fiber-optics surface). The main fiber-optics surface 54 and the counter-fiber-optics surface 58 extend along the main fiber-optics line 18. The fiber-optics surface 52 is limited in the directions perpendicular to the specified surfaces by a lateral fiber-optics surface 56 and another lateral fiber-optics surface lying opposite thereto.

For this, the counter-fiber-optics surface 58 extends parallel, with the main fiber-optics line 18. The main fiber-optics surface 54, in contrast, exhibits a step-like course, wherein the main fiber-optics surface 54 converges in steps toward the counter-fiber-optics surface 58 starting from the coupling section 12 along the main fiber-optics line 18. Overall, the fiber-optics section 52 exhibits, thereby, a design approaching the shape of a wedge.

The main fiber-optics surface 54 of the fiber-optics section 52 exhibits six adjacent, connected terraces 60 along the main fiber-optics line 18. Each pair of adjacent terraces 60 are separated from one another by a step 62. The steps 62 are designed, thereby, such that the main fiber-optics surface 54 approaches the counter-fiber-optics surface 58 in a stepped manner, as can be seen in FIG. 6.

A decoupling component 64-70 is disposed, in each case, on each of the terraces 60 formed by the main fiber-optics surface 54. The decoupling components 64-70 are designed in the manner of the body placed on the main fiber-optics surface 54. Each of the decoupling components 64-70 can be designed in the manner of the decoupling components 30 described above. In this respect, for details, reference is made to the above description of optical fibers 10.

In differing, however, to the optical fiber 10, the individual decoupling components 64-70 are not identical, but, instead, exhibit dimensions deviating from one another.

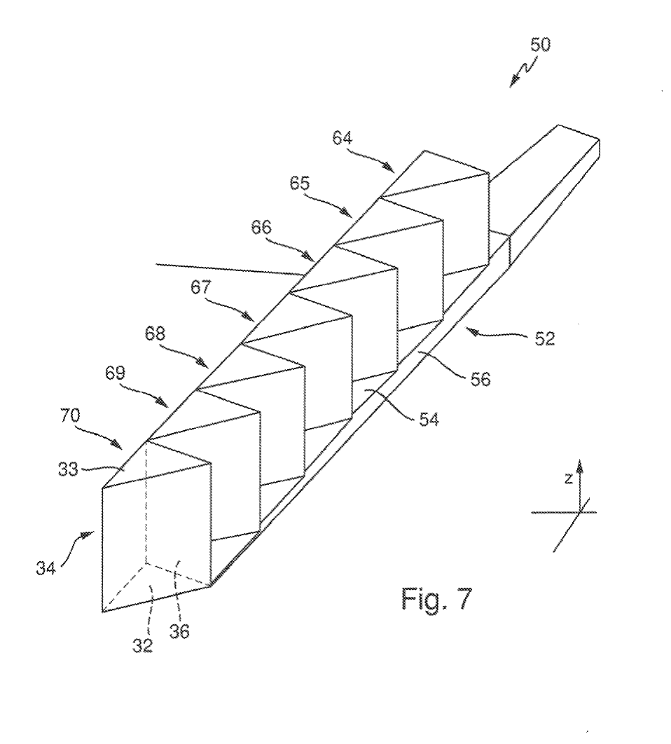

As can be seen in FIG. 7, each of the prism-like decoupling components 64-70 is limited by an identical cover surface 33 designed in the manner of a right triangle-shaped decoupling surface 32 running parallel thereto and a substantially rectangular light-emitting surface 34 extending between the decoupling surface 32 and the cover surface 33. Moreover, another limiting surface is provided by a total-reflection surface 36. The total-reflection surface 36 is bordered thereby, as explained above, in each case, by the hypotenuses of the decoupling surfaces 32 and the cover surfaces 33, which are designed as right triangles.

The decoupling components 64-70 differ from one another only in that, in the direction starting from the decoupling component 64 closest to the coupling section 12, the spacing between the respective cover surface 33 and the decoupling surface 32 increases for each of the decoupling components 64-70.

For this, the decoupling components 64-70 are disposed on the fiber-optics section 52 such that all cover surfaces 33 run at the same height [meaning they lie in a common plane, which runs parallel with the counter-fiber-optics surface 58 (visible in FIG. 6)]. Accordingly, the respective decoupling surface 32 for each of the decoupling components 65-70 lies closer to the counter-fiber-optics surface 58 than with the respective previous decoupling component 64-69. The difference between the respective spacings from the cover surface 33 and the decoupling surface 32 corresponds, thereby, to the respective height of a step 62 between respective adjacent terraces 60.

The length of each terrace 60 along the main fiber-optics line 18 is dimensioned such, thereby, that it corresponds to the expansion of the light-emitting surfaces 34 along the main fiber-optics line 18. In this respect, there is just enough space on each terrace 60 for one decoupling component 64-70.

As can be seen in FIGS. 6 and 7, the steps 62 of the main fiber-optics surface 54 are dimensioned such that the main fiber-optics surface 54 converges with the counter-fiber-optics surface 58 precisely in the region of the decoupling component 70 spaced furthest away from the coupling section 12. Thus, the optical fiber 50 also differs from the optical fiber 10 in that there is no end surface 24 for the fiber-optics section.

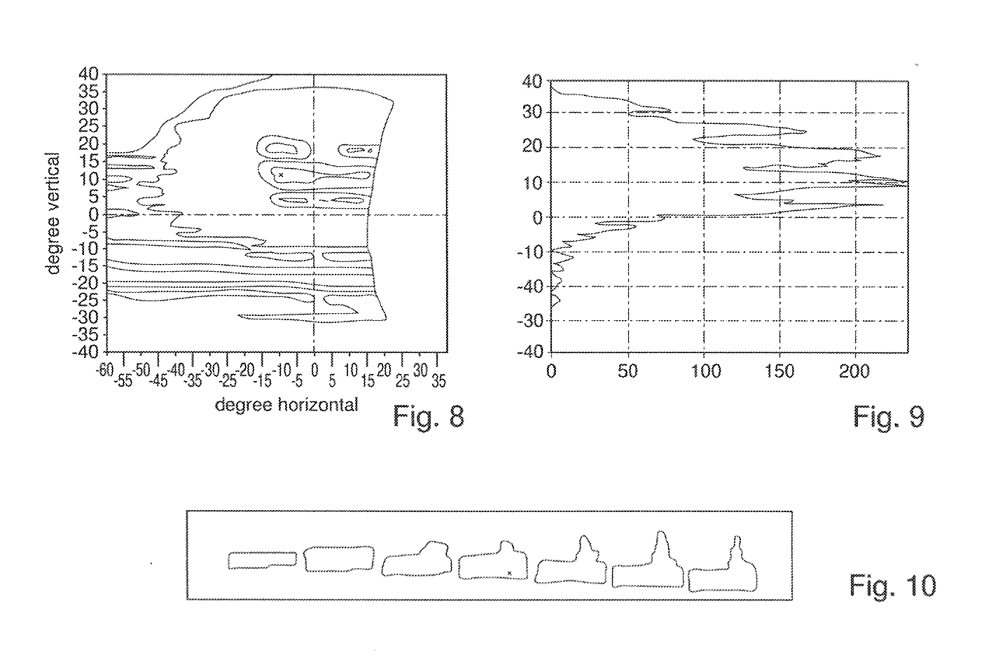

FIGS. 8 and 10 show a depiction of the decoupled light intensity for the optical fiber 50 corresponding to the depiction in FIGS. 3 and 4.

Based on FIG. 8, it is first visible that, in comparison with the optical fiber 10, a significantly greater portion of the light intensity decoupled by the fight-emitting surfaces 34 falls in the upper half of the test screen. This can be attributed to the fact that, due to the tapering optical-fiber cross-section of the fiber-optics section 52 starting from the coupling section 12, light bundles having diminishing (or angular) components in a negative z-axis (see coordinate system in FIG. 7) can be projected into one of the decoupling components 64-70 and, subsequently, can be decoupled in the manner described in reference to the optical fiber 10.

For clarification of the intensity distribution, FIG. 9 shows a section cut through the depiction in FIG. 8 along a vertical plane.

Corresponding to the depiction in FIG. 4, the intensity distribution in a view of an illuminated optical fiber perpendicular to the main fiber-optics line 18 is shown in FIG. 10. It can be seen there that, in differing from the optical fiber 10, the decoupled light intensity for each of the decoupling components 64-70 is nearly identical. For this, the intensity maximums for the different decoupling components—starting from the first decoupling component 64 in the series [intensity maximum (outer left in FIG. 10)] and moving toward the intensity maximum assigned to the decoupling component 70 (far right in FIG. 10)—are offset in steps descending vertically (meaning toward the negative z-axis). This can be attributed to the fact that, due to the step-like convergence of the decoupling surfaces 32 of the various decoupling components 64-70 in the decoupling components spaced further away from the coupling section 12, light bundles—having increasing angular components in the negative z-axis (see FIG. 7) in relation to the main fiber-optics line 18—can be introduced into the respective decoupling component

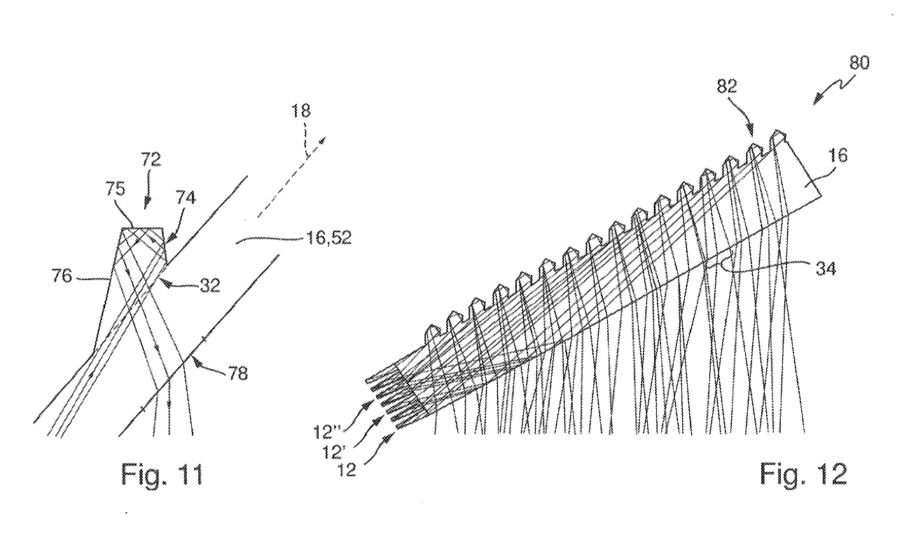

A decoupling component 72 is explained using FIG. 11, which can be disposed on the respective fiber-optics section 16, 52 with optical fibers of the type presently under discussion. The decoupling component 72 is depicted in FIG. 11 in a longitudinal section (meaning in a section cut along the main fiber-optics line 17 of an optical fiber). The decoupling component 72 exhibits, in turn, a decoupling surface 32 by which the decoupling component 72 is connected to the fiber-optics section 16, 52 such that light bundles from the fiber-optics section can be projected into the decoupling component (in FIG. 11, these light bundles are depicted by broken lines).

In differing from the decoupling components 30, 64-70, the decoupling component 72 is designed such that it is limited by at least three additional total-reflection surfaces 74-76. A light bundle entering the decoupling component 72 through the decoupling surface 32 is first fully reflected thereby at the total-reflection surface 74 in accordance with the law of refraction, then strikes the total-reflection surface 75, and, subsequently, the total-reflection surface 76, wherein, in each case, a total, reflection occurs in accordance with the law of refraction. The course of the beam (for the light bundles illustrated with a broken line in FIG. 11) is indicated by arrow heads.

Following the total reflection at the last total-reflection surface 76, the light bundle passes through the entire fiber-optics section 16, 52 and strikes the light-emitting surface 78. In differing from the configuration explained in conjunction with FIGS. 1 and 2 or 5-7, the light-emitting surface 79 is not disposed on the decoupling component 72, but, instead, is disposed on the fiber-optics section 16, 52. For this, the light-emitting surface 78 is located in a region of the fiber-optics section 16, 52 lying opposite the decoupling component 72. This region lies opposite the decoupling component 72 in relation to the main fiber-optics line 18. In this respect, the decoupling component 72 serves exclusively for reflection, in contrast to which the decoupling components 30, 64-70, respectively, also provide (aside from a “reflection” function) a “light emitting” function (light-emitting surface 34). An optical fiber having decoupling components according to FIG. 11 is then also distinguished in that the decoupled light has directional components that are oriented in the opposite direction of the coupled light.

FIG. 12 shows an optical fiber 80, which in turn exhibits a fiber-optics section 16. Numerous decoupling components 82 are disposed on the fiber-optics section 16. The decoupling components 82 are designed, thereby, to be similar to the decoupling components 72 according to FIG. 11. In differing from the decoupling components 72, the decoupling components 82 exhibit, however, an additional fourth total-reflection surface. With the optical fiber 80 as well, the light-emitting surfaces 34 assigned to the decoupling components 82 are not located on the decoupling component 82, but, instead, are each located in the regions of the fiber-optics section 16 lying opposite the decoupling components 82.

The optical fiber 80 also differs from the optical fiber 10 in that numerous coupling sections 12, 12′, 12″ . . . are provided each of which has its own coupling surfaces for guiding light into the optical fiber 80. Each individual coupling section 12, 12′, 12″ . . . is designed, thereby, in the manner described for the optical fiber 10.

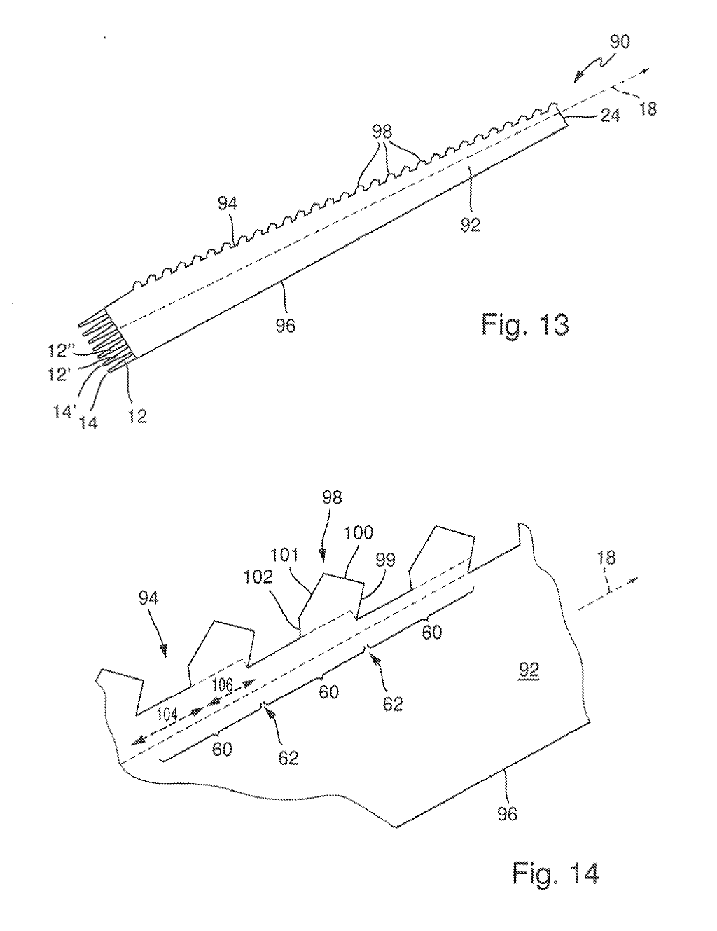

FIG. 13 shows an optical fiber 90, which is improved with respect to the optical fiber 80. This optical fiber 90 exhibits, in turn, numerous coupling sections 12, 12′, 12″ . . . each of which has coupling surfaces 14, 14′, 14″ . . . for conducting light into the optical fiber 90. The optical fiber 90 also has a fiber-optics section 92, which extends along a main fiber-optics line 18.

The fiber-optics section 92 is depicted in FIG. 13 in a longitudinal section cut through the main fiber-optics line 18. In the section in FIG. 13, it can be seen that the fiber-optics section 92 is limited by a main fiber-optics surface 94 and a counter-fiber-optics surface 96 lying opposite the main fiber-optics surface. For this, the counter-fiber-optics surface 96 extends parallel with the main fiber-optics line 18. The main fiber-optics surface 94, in contrast, is designed such that it converges in steps toward the counter-fiber-optics surface 96 starting from the coupling sections 12, 12′, 12″ . . . along the main fiber-optics line 18, which shall be explained in greater detail below based on FIG. 14.

With the optical fiber 90, a number of decoupling components 98 are disposed successively on the main fiber-optics surface 94 along the main fiber-optics line 18. As a result, the fiber-optics section 92 exhibits, in the longitudinal section depicted in FIG. 13, a saw-tooth-like boundary formed by the main fiber-optics surface 94.

To clarify the step-like course of the main fiber-optics surface 94, FIG. 14 shows a section from the perspective according to FIG. 13. Each of the decoupling components 98 are limited in the longitudinal section shown by four edge surfaces 99-102, which form total-reflection surfaces like those explained in reference to FIGS. 11 and 12.

The fiber-optics section 92 is designed, thereby, such that the main fiber-optics surface 94 exhibits numerous terraces bordering one another along the main fiber-optics fine 18, wherein each pair of adjacent terraces 60 are separated from one another by a step 62. The step 62 is designed, thereby, such that the main fiber-optics surface 94 (or the terraces 60) converge on the counter-fiber-optics surface 96 lying opposite in a stepped manner. As a result, the fiber-optics section 92 exhibits an effective optical-fiber cross-section in a section perpendicular to the main fiber-optics line 18, which decreases in a stepped manner in the depictions of FIGS. 13 and 14 from left to right (meaning, starting from the coupling section 12, in the direction of the main fiber-optics line 18).

Each of the terraces 60 includes a sub-section 104 and an adjacent decoupling region 106 of the fiber-optics section 92. For this, the fiber-optics section 92 is designed in the region of the sub-section 104 such that a constant optical-fiber cross-section perpendicular to the main fiber-optics line 18 is provided in the region of the sub-section 304 along the main fiber-optics line 18.

A decoupling component 98 is disposed on each of the terraces 60 in each of the decoupling regions adjacent to the respective sub-sections 104. Thus, along the saw-tooth-like course of the main fiber-optics surface 94, each pair of adjacent decoupling components 98 are separated from one another by a sub-section 104, wherein a step 62 is formed in each case between each pair of successive sub-sections 104.

In this respect, the terraces 60 in the optical fiber 90 differ from the terraces 60 explained in conjunction with the optical fiber 50 in that, with the optical fiber 90, the terraces 60 along the main fiber-optics line 18 include not only a decoupling component in each case, but also a sub-section 104.

In all of the embodiments that exhibit a main fiber-optics surface having terraces 60, steps having a consistent height or steps each having different heights between the adjacent terraces can be selected for the successive terraces 60 along the main fiber-optics line 18. In particular, it is conceivable to define a “vertical” function, in relation to the position along the main fiber-optics line 18, for a vertical profile of the steps 62 between terraces 60.

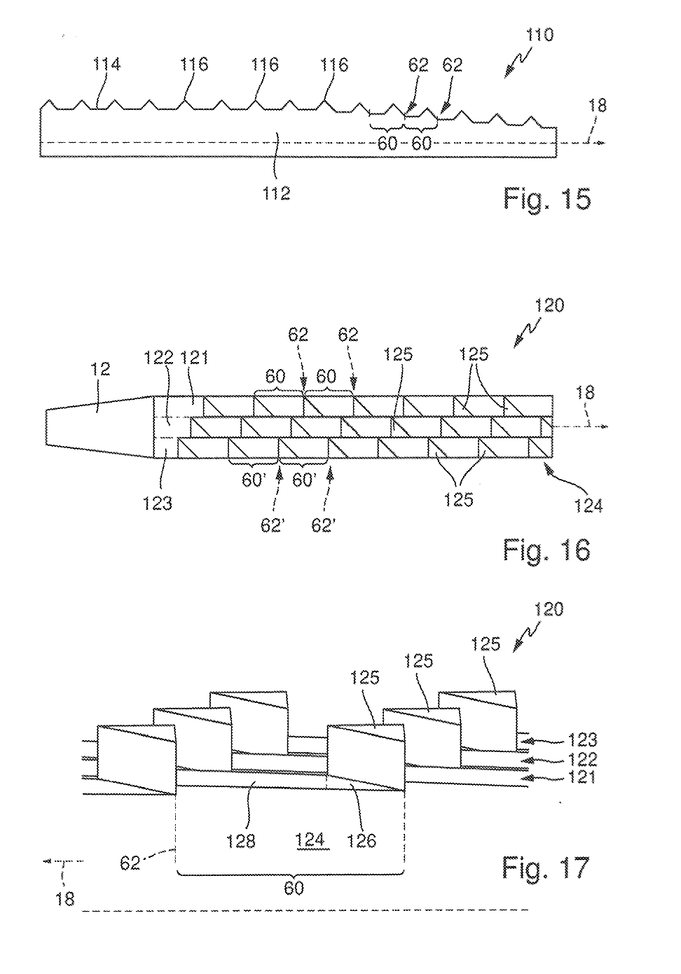

Another optical fiber 110 according to the invention shall be explained based on FIG. 15. For this, in FIG. 15, only the fiber-optics section 112 is depicted in a longitudinal section cut along the main fiber-optics line 18. The optical fiber 110 exhibits in turn a main fiber-optics surface 114, which is designed having numerous terraces 60 disposed in a series. Adjacent terraces 60 are separated from one another by steps 62. The optical-fiber cross-section of the fiber-optics section 112 decreases at each step 62 in a stepped manner. In differing from the optical fiber 90 as set forth in FIG. 13 and FIG. 14, however, the height of the steps does not remain constant along the course of the fiber-optics section 112 in the direction of the main fiber-optics line 18. Instead, the steps 62 exhibit a height, which decreases starting from the one (not shown in FIG. 15) region of the fiber-optics section 112 fecing the coupling section, in the direction of the main fiber-optics line 18. For this, the steps 62 in the region of the fiber-optics section 112 facing away from the coupling section (not shown therein) are deeper. Thus, the optical-fiber cross-section of the fiber-optics section 112 decreases increasingly as the spacing from the coupling section increases in its course along the main fiber-optics line 18.

FIGS. 16 and 17 show another optical fiber 120 according to the invention. Characteristic of the optical fiber 120 is that it exhibits a first main fiber-optics surface 121, a second main fiber-optics surface 122, and a third main fiber-optics surface 123, which run in stripes adjacent to one another and extend along the main fiber-optics line 18 starting from the coupling section 12.

In turn, the main fiber-optics surface 121 exhibits terraces 60 thereby, which are adjacent to one another along the main fiber-optics line 18, and each transition into one another via steps 62. The optical-fiber cross-section of the optical fiber 120 decreases at each step 62 in a stepped manner insofar as the terraces 60 are designed in the manner already explained in reference to FIGS. 13 and 14 or 5 and 6, respectively.

With the optical fiber 120, the second main fiber-optics surface 122 running adjacent to the first main fiber-optics surface 121 as well as the third main fiber-optics surface 123 running, in turn, next to this also exhibit corresponding terraces with steps (for example, for the third main fiber-optics surface 123, terraces 60′ separated by steps 62′). For this, the main fiber-optics surfaces 121-123 are designed such that the steps of the first main fiber-optics surface 121 are offset in relation to the corresponding steps of the adjacent second main fiber-optics surface 122 along the main fiber-optics line 18. Thus, each terrace 60 of the first main fiber-optics surface 121 overlaps two terraces of the second main fiber-optics surface 122 in the direction following the main fiber-optics line 18. The same applies for the terraces of the second main fiber-optics surface 122 in relation to the terraces 60′ of the third main fiber-optics surface 123.

One decoupling component 125 is disposed on each of the terraces 60, 60′ of the main fiber-optics surfaces 121-123. These decoupling components 125 are designed in a manner corresponding to the decoupling components 30 for which reason reference is made to the preceding description for details thereto. FIG. 17 shows the fiber-optics section 124 of the optical fiber 120 in a perspective view looking at the main fiber-optics surfaces 121-123 and the decoupling component 125.

Accordingly, each terrace 60 includes a decoupling region 126 and a sub-section 128. The fiber-optics section 124 exhibits a consistent optical-fiber cross-section in the region of the fiber-optics section 124. In this respect, each main fiber-optics surface 121-123 runs parallel, in the region of a respective decoupling region 126, to a counter-fiber-optics surface 130 (indicated in FIG. 17 by a broken line) bordering a main fiber-optics surface 121-123 lying opposite the fiber-optics section 124.

One decoupling component 125 is disposed, in the manner explained for the optical fibers described above, on the decoupling region 126.

Each sub-section 128 is distinguished in that the optical-fiber cross-section of the fiber-optics section 124 increases over the course of the sub-section 128 in the direction, starting from the coupling section, along the main fiber-optics line 118. This is obtained in that the terrace 60 is tilted in the region of the sub-section 128 in relation to the counter-fiber-optics surface 130 such that the spacing of the corresponding main fiber-optics surfaces 121-123 from the counter-fiber-optics surface 130 increases. The increase in the optical-fiber cross-section along the sub-section 128 is selected such that it is smaller, thereby, than the decrease in the optical-fiber cross-section at the corresponding step 62, where the terrace 60 transitions into the adjacent terrace. By this, it is ensured that the optical-fiber cross-section of the fiber-optics section 128 effectively decreases at each of the steps 62.

It should be appreciated by those having ordinary skill in the related art that the invention has been described above in an illustrative manner, it should be so appreciated also that the terminology that has been used above is intended to be in the nature of words of description rather than of limitation. It should be so appreciated also that many modifications and variations of the invention are possible in light of the above teachings. It should be so appreciated also that, within the scope of the appended claims, the invention may be practiced other than as specifically described above.

What is claimed is:

1. An optical fiber (50, 90, 110, 120) for a lighting device, the optical fiber (50, 90, 110, 120) comprising:
a coupling section (12) that exhibits at least one coupling surface (14) for coupling of light in the optical fiber (50, 90, 110, 120);
a fiber-optics section (52, 92, 112, 124) that extends along a main fiber-optics line (18) that is limited by at least one main fiber-optics surface (54, 94, 114, 121-123) extending along the main fiber-optics line (18) and such that light can be conducted, starting from the coupling section (12), by total reflection at the main fiber-optics surface (54, 94, 114, 121-123) along the main fiber-optics line (18); and
a plurality of decoupling components (30, 64-70, 72, 82, 98, 116, 125), wherein each of the decoupling components (30, 64-70, 72, 82, 98, 116, 125) is disposed on the main fiber-optics surface (54, 94, 114, 121-123) such that light from the optical fiber (50, 90, 110, 120) can be fully decoupled by a light-emitting surface (38, 78) of the optical fiber (50, 90, 110, 120) assigned in each case thereto, the decoupling components (30, 64-70, 72, 82, 98, 116, 125) are disposed on the main fiber-optics surfaces (54, 94, 314, 121-123) such that they are offset along the main fiber-optics line (18), and the fiber-optics section (52, 92, 112, 124) exhibits regions having an optical-fiber cross-section decreasing in a direction starting from the coupling section (12) along the main fiber-optics line (18).

2. The optical fiber (50, 90, 110, 120) according to claim 1, wherein dimensions of the optical-fiber cross-section decrease along the main fiber-optics line (18) in a direction substantially perpendicular to the main fiber-optics surface (54, 94, 114, 121-123).

3. The optical fiber (50, 90, 110, 120) according to claim 1, wherein dimensions of the fiber-optics section (52, 92, 112, 124) either of decrease and remain same along the main fiber-optics line (18) in a direction substantially parallel with the main fiber-optics surface (54, 94, 114, 121-123).

4. The optical fiber (50, 90, 110, 120) according to claim 1, wherein the fiber-optics section is in a shape of either of substantially a plate and rod.

5. The optical fiber (50, 90, 110, 120) according to claim 1, wherein at least one of the fiber-optics section (52, 121-123) and main fiber-optics surface is either of curved or defines multiple curves.

6. The optical fiber (90) according to claim 1, wherein the fiber-optics section (92) exhibits an end surface (24) that limits the fiber-optics section (92) in a direction facing away from the coupling section (12) along the main fiber-optics line (18) and the end surface (24) exhibits a smaller surface than the smallest optical-fiber cross-section.

7. The optical fiber (50, 90, 110, 120) according to claim 1, wherein the end surface (24) is disposed such that, for a light bundle running along the main fiber-optics line (18) in the fiber-optics section (16), an internal total reflection occurs at the end surface (24).

8. The optical fiber (50, 90, 110, 120) according to claim 1, wherein one of the decoupling components (30, 64-70, 72, 82, 98, 125) exhibits at least one total-reflection surface (36, 74-76, 99-102) that is disposed such that, for a light bundle running from the fiber-optics section (52, 92, 112, 124) into the decoupling component (30, 64-70, 72, 82, 98, 125), an internal total reflection occurs.

9. The optical fiber (50, 90, 110, 120) according to claim 1, wherein the light-emitting surface (34, 78) assigned to the respective decoupling component (30, 64-70, 72, 82, 98, 125) is disposed on either of the respective decoupling component (30, 64-70) and fiber-optics section (16).

10. The optical fiber (50) according to claim 1, wherein the decoupling components (64-70) are disposed along the main fiber-optics line (18) substantially directly adjacent to one another on the main fiber-optics surface (54).

11. The optical fiber (90, 110, 120) according to claim 1, wherein the fiber-optics section (52, 92, 112, 124) exhibits a plurality of sub-sections (104) and one of the sub-sections (104) is disposed between each pair of successive decoupling components (98, 116, 124) along the main fiber-optics line (18).

12. The optical fiber (120) according to claim 1, wherein a sub-section (128) exhibits, at least in sections, an increasing optical-fiber cross-section along the main fiber-optics line (18).

13. The optical fiber (50, 80, 110, 120) according to claim 1, wherein the main fiber-optics section (54, 94, 114, 121-123) exhibits a plurality of terraces (60) along the main fiber-optics line (18) and one of the decoupling components (64-70, 98, 116, 125) is disposed on each of the terraces (60).

14. The optical fiber (50, 90, 110, 120) according to claim 13, wherein the fiber-optics section (52, 92, 112, 124) exhibits a step (62) between two successive ones of the terraces (60) along the main fiber-optics line (18) in a direction starting from the coupling section (12) such that the optical-fiber cross-section decreases in a stepped manner.

15. The optical fiber (90) according to claim 13, wherein each of the terraces (60) includes a sub-section (104) and a decoupling region (a) bordering the sub-section (104), one of the decoupling components (98) is disposed on the decoupling region (106), and the fiber-optics section (92) exhibits a substantially constant cross-section in the decoupling region (106).

16. The optical fiber (120) according to claim 1, wherein the fiber-optics section (124) is limited by at least one additional main fiber-optics surface (122, 123) that runs substantially parallel with either of the first main fiber-optics surface (121) and another of the additional main fiber-optics surface (122, 123).

17. The optical fiber (120) according to claim 16, wherein a plurality of the decoupling components (125) are disposed on the additional main fiber-optics surface (122, 123) such that light from the optical fiber (120) can be fully decoupled by a respective light-emitting surface of the optical fiber (120) assigned thereto and the decoupling components (125) on the additional main fiber-optics surfaces (122, 123) and the decoupling components (125) on a first main fiber-optics surface (123) are disposed such that they are offset to one another along the main fiber-optics line (18).

18. The optical fiber (120) according to claim 16, wherein the additional main fiber-optics surfaces (122, 123) and the first main fiber-optics surface (121) exhibit same dimensions substantially perpendicular to the main fiber-optics line (18).

19. The optical fiber (90) according to claim 1, wherein the coupling section (12) exhibits a plurality of coupling surfaces (14, 14′, 14″).

20. A fiber-optics device comprising:
first and second optical fibers (50, 90, 110, 120) each of which includes:
a coupling section (12) that exhibits at least one coupling surface (14) for coupling of light in the optical fiber (50, 90, 110, 120);
a fiber-optics section (52, 92, 112, 124) that extends along a main fiber-optics line (18) that is limited by at least one main fiber-optics surface (54, 94, 114, 121-123) extending along the main fiber-optics line (18) and such that light can be conducted, starting from the coupling section (12), by total reflection at the main fiber-optics surface (54, 94, 114, 121-123) along the main fiber-optics line (18); and
a plurality of decoupling components (30, 64-70, 72, 82, 98, 116, 125), wherein each of the decoupling components (30, 64-70, 72, 82, 98, 116, 125) is disposed on the main fiber-optics surface (54, 94, 114, 121-123) such that light from the optical fiber (50, 90, 110, 120) can be fully decoupled by a light-emitting surface (38, 78) of the optical fiber (50, 90, 110, 120) assigned in each case thereto, the decoupling components (30, 64-70, 72, 82, 98, 116, 125) are disposed on the main fiber-optics surfaces (54, 94, 114, 121-123) such that they are offset along the main fiber-optics line (18), the fiber-optics section (52, 92, 112, 124) exhibits regions having an optical-fiber cross-section decreasing in a direction starting from the coupling section (12) along the main fiber-optics line (18), and the first optical fiber (50, 90, 110, 120) is connected by an end section, which limits the first optical fiber (50, 90, 110, 120) in a direction substantially opposite the coupling section (12) of the first optical fiber (50, 90, 110, 120), to an end section of the second optical fiber (50, 90, 110, 120), which limits the second optical fiber (50, 90, 110, 120) in a direction substantially opposite the coupling section (12) of the second optical fiber (50, 90, 110, 120).
